(19) United States
(12) Patent Application Publication
(10) Pub. No.: US 2022/0266657 A1
(43) Pub. Date: Aug. 25, 2022

(54) MOTOR VEHICLE AND METHOD FOR ADAPTING AN AVAILABLE HEATING POWER IN A MOTOR VEHICLE

(71) Applicant: AUDI AG, Ingolstadt (DE)

(72) Inventor: Sebastian KIRSCHNER, Ingolstadt (DE)

(21) Appl. No.: 17/678,863

(22) Filed: Feb. 23, 2022

(30) Foreign Application Priority Data
Feb. 24, 2021 (DE) 102021104371.9

(51) Int. Cl. B60H 1/22; B60H 1/00; B60K 1/04; B60L 58/27

(52) U.S. Cl. CPC B60H 1/2221; B60H 1/00278; B60K 1/04; B60L 58/27; B60H 2001/2278; B60K 2001/008

(57) ABSTRACT

A motor vehicle, especially an electrically operated motor vehicle, having a heating fluid circuit by which a heating fluid, especially water, can be taken to at least one component of the motor vehicle which is to be heated, and a heating device to heat the heating fluid, wherein the heating device comprises a basic component mounted in the motor vehicle, comprising a heating duct, which is part of the heating fluid circuit, and electrical connectors, which are connected to an onboard network of the motor vehicle, wherein the basic component comprises multiple interfaces for heating modules configured separately from the basic component, each of them comprising a current connection to the power supply of the respective heating module and being adapted to hold the respective heating module, while at least one of the interfaces is occupied by a heating module the operation of which provides heat for heating the heating fluid carried through the heating duct.

### BACKGROUND

### Technical Field

Embodiments of the invention relate to a motor vehicle, especially an electrically operated motor vehicle, having a heating fluid circuit by which a heating fluid, especially water, can be taken to at least one component of the motor vehicle which is to be heated, and a heating device to heat the heating fluid, wherein the heating device comprises a basic component mounted in the motor vehicle, comprising a heating duct, which is part of the heating fluid circuit, and electrical connectors, which are connected to an onboard network of the motor vehicle. In addition, embodiments of the invention relate to a method for adapting an available heating power in a motor vehicle.

### Description of the Related Art

In electrically operated motor vehicles, the heating of the vehicle, both the interior and also a water circuit for the heating of high-voltage components, occurs primarily through electric heaters, since no waste heat of an internal combustion engine is available for the heating. High-voltage heaters may be used, being connected on the one hand to a high-voltage onboard network of the motor vehicle and on the other hand to a water or general heating fluid circuit, in order to bring heat to the components being heated. For example, a corresponding heating of a battery is discussed in document CN 109301396 A.

Motor vehicles once they are sold are typically used in certain regions which may differ significantly in terms of the minimum temperatures reached and thus in terms of the required heating power. It is therefore known how to offer motor vehicles with different heating powers. For example, the customer when ordering the motor vehicle may select a heating power between 3 kW and 9 kW in certain predetermined stages. In this way, one may quickly bring the vehicle up to the temperature in the anticipated region of operation without having to carry along an unnecessary weight.

However, the problem here is that a retrofitted adaptation of the available heating power is only possible with considerable expense, since ultimately the entire heating device has to be replaced, requiring at least time spent in the repair shop and an ordering of additional components. Such a retrofitting is typically not done, on account of this large expense. But this may result in considerable sacrifice of comfort when the region of use is changed, for example during lengthy travel, when the user moves to a new location, or when the vehicle is sold to another region, since a sufficiently rapid heating of the vehicle components is no longer possible and thus, for example, the interior temperature remains chilly for a long time or it takes a relatively long time for the full driving performance of the motor vehicle to become available. Also a switch to warmer regions may be unfavorable without such a retrofitting, since a needlessly heavy heating device will need to be carried along, if no retrofitting is done.

### BRIEF SUMMARY

Some embodiments include adapting the available heating power in a motor vehicle with less expense, in particular making it possible for a vehicle user or owner to perform such a retrofitting by themself, with little expense.

Some embodiments include a motor vehicle of the kind mentioned above, wherein the basic component comprises multiple interfaces for heating modules configured separately from the basic component, each of them comprising a current connection to the power supply of the respective heating module and being adapted to hold the respective heating module, while at least one of the interfaces is occupied by a heating module the operation of which provides heat for heating the heating fluid carried through the heating duct.

By providing multiple interfaces at the basic component, a needs-based adaptation of the number and type of heating modules used is made possible, so as to adapt the available heating power of the heating device by removing, installing, or replacing the heating modules with little expense. In particular, the overall heating power of the heating device can be provided by the at least one heating module. Alternatively, however, it would also be possible for the basic component itself to comprise already at least one heating element to provide a basic heating power, and this basic heating power can be further increased as demand dictates by the heating power of the connected heating modules.

The basic component may comprise, in particular, a vehicle-installed control device, by which the heating power of the individual heating modules can be controlled. Alternatively, however, a vehicle-installed control device of the motor vehicle which is configured separately from the heating device can be used, and in this case the corresponding control or communication signals may be relayed from the external control device across the basic component to the respective interfaces.

The electrical connection may be, in particular, a connection to a high-voltage network, in order to provide high voltage for the operation of the heating modules or the heating elements located in them. If, in addition, a low-voltage network is also present in the motor vehicle, for example a 12 V network, the basic component may also have electrical leads for connection to the low-voltage network, thereby making possible for example an energization of a vehicle-installed control device in the basic component with little expense. In this case, the individual heating modules may also be provided with both a low-voltage power supply and a high-voltage power supply by the respective interface, while the low-voltage power supply may serve, for example, to operate a local control device of the respective heating module, a sensor located there, or the like.

In order to exchange control or communication signals with other devices of the motor vehicle, such as a central control device, a vehicle network or bus, or the like, the basic component may have further electrical connectors, or corresponding electrical connectors may be provided for example by a common plug connection with a low-voltage power supply. The respective interface may also have connectors for control and/or communication signals, i.e., a data connection, on the one hand for the communication with a control device situated in the basic component and/or on the other hand for the communication with components external to the heating device, e.g., by a corresponding connector of the basic component.

The high-voltage range in the present case shall be considered to be alternating voltages of more than 30 V or DC voltages of more than 60 V. Onboard networks in motor vehicles typically provide DC voltages and heating elements are also typically operated with DC voltage, so that DC voltages are primarily relevant for the operation of the heating device.

A particular heating module can provide a maximum heating power between 1 kW and 3 kW. All of the heating modules which are used or which can be used have the same maximum power. In some embodiments, however, heating modules with heating powers different from each other can also be used at the same time at different interfaces. In particular, PTC heating elements can be used as the heating element or the component of the respective heating module providing the heating power, since these are self-regulating to a certain degree thanks to the use of a conductor with a positive temperature coefficient for generating heat by resistance.

The heating fluid circuit may be used only in certain operating states of the motor vehicle for the heating of the respective component. In particular, the heating fluid circuit may serve for cooling of components in other operating states and thus may be called in general a temperature control fluid circuit, and the heating fluid may be called in general a temperature control fluid. But since in the present instance we are dealing with a heating of components by the heating device and the heating fluid circuit, terminology has been chosen which deals with heating, for a better comprehension. The described possibility of also using the heating fluid circuit for a cooling may be especially advisable when the heated or cooled component is a battery or a power electronics, since these components typically need to be cooled during lengthy operating times. However, an initial heating may be advantageous, for example during a cold start, in order to reduce the internal resistance of a battery or the residual resistance of an open switched semiconductor switch and thus enhance the performance.

The respective heating module may encompass at least one heating element and a local control device, wherein the local control device is adapted to receive communication signals via at least one data connection implemented by the interface and to control the energization of the heating element in dependence on these communication signals. Corresponding communication signals can be sent by a control device situated in the basic component or by a control device external to the heating device and relayed through the basic component. Such a communication in particular means that the specific configuration of the heating elements need only be taken into account in the operation of the local control device, for example during its programming, and a communication can be done through relatively abstract commands via the data connection. For example, the data connection can be used to transmit the command that a particular heating power needs to be provided or that a heating should be done up to a particular temperature. This makes it possible, in particular, to also control heating modules having a different internal layout in the same manner and to operate them easily together in the same basic component.

The data connection may also allow in particular a communication in the reverse direction, for example, to provide sensor data to a control device for monitoring the respective heating module or to provide parameters of the heating module, such as the maximum heating power which can be provided by the particular heating module, the time constants with which the heating module can respond to a change in heating power requirements, or the like.

In some embodiments, the motor vehicle encompasses a vehicle-installed control device, which is adapted to control the heating power of the respective heating module by a communication with the local control device or one of those devices, which is part of the respective heating module, and/or by setting the power provided via the current connection to the respective heating module. The vehicle-installed control device may be in particular part of the basic component, but it may also be configured separately from the heating device and situated for example at a distance from it.

The communication may occur in that the local control device communicates as a subscriber through a bus of the vehicle or a network of the vehicle, which also serves for communication with further components.

Alternatively, it may be advantageous for the local control device to communicate with the vehicle-installed control device by a dedicated data connection, which for example provides functionality not available in other vehicle-installed buses or networks. In this way, complex communication functions, such as service-based architectures or the like, can be implemented. Alternatively, a dedicated data connection can also make possible a communication making possible a particularly simple configuration of the local control devices. For example, a power control is possible by a pulse width of a communication signal. The communication may occur through the data connection or through a data connection implemented by the interface.

The vehicle-installed control device may be adapted to acquire on the one hand an occupancy information, which indicates whether a respective interface is occupied by a heating module and/or describes the at least one parameter of the heating module occupying the interface, and on the other hand to control the current heating power of the at least one heating module present in the heating device in dependence on the occupancy information. In particular, the heating power of at least one heating module occupying a first interface may be set in dependence on whether another interface is occupied or how many other interfaces are occupied or what the parameters are, especially the maximum powers, of the heating modules by which the other interfaces are occupied. This can make it possible to provide a desired overall heating power in that the current heating powers are set for the individual available heating modules which add up to the desired overall heating power, wherein for example the most uniform possible distribution of the demanded heating power among the heating modules can be achieved.

A recognition of whether a particular interface is occupied by a heating module or an interrogating of parameters of the respective heating module can be accomplished by digital communication with the local control device of that heating module. However, corresponding information may also be obtained without the use of a local control device, for example, when a heating module connected to the interface connects the electrical connectors of the interface across a defined resistance in order to signal that the heating module is present or in order to relay certain parameters. For example, a hard-wired resistance can be provided between two particular electrical contacts of the heating module, so that the maximum heating power of that heating module can be communicated, for example, by suitable choice of the resistance value.

A recognition of whether a particular interface is occupied by a heating module may also serve for other purposes. For example, if a configuration of the heating device explained further below is used, in which the heating fluid is taken through a respective module duct of the respective heating module, fluid ports of the interface may be closed with valves or the like when the interface is not occupied, and these will only be opened during the operation of the motor vehicle if an occupation of this interface has been previously recognized, for example by a communication with a local control device of the heating module.

It may also be advantageous to only energize a high-voltage supply for the individual heating module at the respective interface if an occupation of that interface has been previously recognized. For example, there may occur at first only a low-voltage supply of the heating module and an energizing with high voltage may only occur after being released by the local control device of the respective heating module. This may be advisable, for example, for reasons of protecting against electric shock.

The heating duct may be closed fluid-tight, except for a fluid inflow connected to the heating fluid circuit and a fluid outflow connected to the heating fluid circuit. In particular, therefore, no portion of the heating module may be in contact with the heating fluid present in the heating fluid circuit. Such a configuration may be advantageous, since the heating modules are thus dry and no seal is required at a connection between the respective heating module and the basic component.

The or a heating element of the respective heating module may contact the heating duct directly or across a heat conduction means, especially a heat pipe. The heating element or the heat conduction means may lie flat against a side wall of the heating duct and in particular be pressed with a defined force against this side wall, for example, by a spring or another elastic element. This makes it possible to heat efficiently the heating fluid contained in it, despite the closed heating duct.

In one alternative embodiment, the respective interface may comprise fluid ports for the respective heating module, wherein the at least one heating module comprises a module duct, which is connected via the fluid ports of the respective interface occupied by the respective module to the heating duct. By taking the heating fluid through the heating module, a better heat transfer and a faster response of the heating device may be achieved. But in this case it is necessary for the fluid ports to be tightly closed upon connecting the respective heating module and for the fluid ports to be closed in cases when the respective interface is not occupied by any heating module. As mentioned above, this can be achieved by a suitable valve control or the like. However, self-sealing fluid ports may also be used.

The vehicle-installed control device or a processing device of the motor vehicle can be adapted to predict a presumably required heating power of the heating device based on the current position and/or a planned travel destination and/or a planned travel route of the motor vehicle, to select in dependence on this a suitable occupancy of the interfaces by heating modules and to actuate an output device of the motor vehicle to put out an occupancy information regarding the suitable occupancy to a user and/or to relay this to an external device. For the direct output to a user, it is possible to use for example a display device, such as a graphic display or signal lights, or there may be a loudspeaker output. The external device may be in particular a communication device of the user, such as a smartphone, a tablet or the like.

In one modification of the above described method it is possible in particular to only indicate the occupancy information when a change in the occupancy of the interfaces is advisable, for example, when it becomes known, based on a planned travel destination, that a higher heating power is required there for optimal comfort than is achieved with the presently occupied heating modules.

The suitable occupancy may be chosen such that a presumably maximum required heating power is achieved or at least a predetermined reserve level is surpassed, for example, a minimum number of heating modules or a combination of heating modules with minimum weight is used.

The prediction of the required heating power may be done in particular on the basis of anticipated outdoor temperatures, and it may also take into account in particular the outdoor temperatures anticipated for certain operating states, especially when a cold start is necessary. The anticipated outdoor temperatures may be dictated solely for the locality, for example, by using a suitable map. In some embodiments, however, a time-dependent determination will be done, so that for example a distinction can be made between a cold start during the day and at night in a particular region, and/or it is possible to take into account seasons of the year and/or a weather forecast received from an external device.

In order to keep down the expense of an adding or removing of heating modules or for a replacement of heating modules, it is advantageous for the interfaces to be arranged with easy access in the vehicle. For example, they may be directly accessible in the front of the vehicle and the front hood, or be arranged there or also in the trunk or in the interior beneath a cover, for example, which can be removed in particular without a tool.

The respective interface and the respective heating module may be adapted so that a connecting of the respective heating module to and/or a disconnecting of the respective heating module from the interface is possible without a tool. If separate steps are provided for securing the heating module at the interface or for removing this securing, such as the use of a cover or a securing strap, these steps can also be performed without a tool.

The heating module may be designed, for example, as a plug-in module, being led through the interface and held in force-locking manner. Optionally, an additional securing can be realized, for example by at least one detent lug, a snap hook, a mechanical bar or a cover.

The heating fluid circuit may be adapted to take the heating fluid to a heat exchanger for air being supplied to the interior of the motor vehicle and/or to a battery and/or to a power electronics and/or to an electric machine as the component being heated. If air being supplied to the interior of the motor vehicle is heated by such a heat exchanger, it may be advantageous to provide an additional heating element which further heats the air in series, upstream or downstream from the heat exchanger, before it is supplied to the interior. This may be advantageous, since the heating fluid circuit has a certain thermal inertia and thus the exclusive heating of the interior by the heating fluid circuit and the heat exchanger might not afford the optimal comfort, since an adequate heating of the interior takes a relatively long time.

As the power electronics, it is possible to heat for example a DC/DC converter, a pulse inverter, especially for a propulsion motor of the motor vehicle, a charger electronics and/or the like. For the mentioned components there is typically provided a temperature control possibility any way, which is used in normal operation of the motor vehicle for the cooling of that component. For example, in the case of a cold start at low temperatures, if the temperature of these components is too low, the performance of the motor vehicle may be significantly impaired, for example, due to a large internal resistance of the battery or low conductivity of semiconductors. It may therefore be advantageous to heat these components at least temporarily by the heating fluid circuit.

Besides the motor vehicle, embodiments of the invention relate to a method for adapting an available heating power in a motor vehicle, especially in an electrically operated motor vehicle, wherein the motor vehicle comprises a heating fluid circuit by which a heating fluid, especially water, can be taken to at least one component of the motor vehicle which is to be heated, and a heating device to heat the heating fluid, wherein the heating device comprises a basic component mounted in the motor vehicle, comprising a heating duct, which is part of the heating fluid circuit, and electrical connectors, which are connected to an onboard network of the motor vehicle, wherein the basic component comprises multiple interfaces for heating modules configured separately from the basic component, each of them comprising a current connection to the power supply of the respective heating module and being adapted to hold the respective heating module, wherein the respective interfaces are occupied by a heating module the operation of which provides heat for heating the heating fluid carried through the heating duct, and the available heating power is adapted in that at least one not yet occupied interface is occupied by a heating module and/or at least one heating module occupying an interface is removed from it and/or replaced by another heating module.

Replacing a heating module to adapt the available heating power may be advisable when the replaced heating module has a different maximum heating power than the heating module which replaces it. As the motor vehicle, one can use in particular the motor vehicle described herein, while it is also possible for none of the interfaces to be occupied by a heating module at the start of the method or at the end of the method. This may be the case, in particular, when the basic component itself already comprises heating elements which provide a basic heating power.

The features explained for the motor vehicle described herein can also be transferred to the method described herein, and vice versa.

In a method, a current position and/or a planned travel destination and/or a planned travel route of the motor vehicle can be ascertained and a processing device can predict the presumably required heating power of the heating device based on the current position and/or the planned travel destination and/or the planned travel route of the motor vehicle and a suitable occupancy of the interfaces by heating modules can be selected in dependence on this and an occupancy information regarding the suitable occupancy can be put out to a user.

A corresponding method has already been discussed above for the case when the determination of the suitable occupancy is done by a vehicle-installed control device or a processing device of the motor vehicle and an output device of the motor vehicle is used for the output. Alternatively, however, it is also possible in the method described herein to use a vehicle-installed device for only one of these tasks, or for both the determination of the suitable occupancy and the output of the occupancy information to be done independently of the vehicle. For example, these functions can be provided by an app of a smartphone or the user may consult a backend server, for example one of the vehicle manufacturer, via an Internet connection, which provides the mentioned functions or at least some of these functions.

### BRIEF DESCRIPTION OF THE SEVERAL VIEWS OF THE DRAWINGS

Further advantages and details are illustrated in the corresponding drawings.

FIG. 1 shows an embodiment of a motor vehicle used in the context of a method described herein.

FIGS. 2 and 3 show detail views of a heating device of the motor vehicle shown in FIG. 1.

FIG. 4 shows a detail view of a heating device of another embodiment of a motor vehicle.

### DETAILED DESCRIPTION

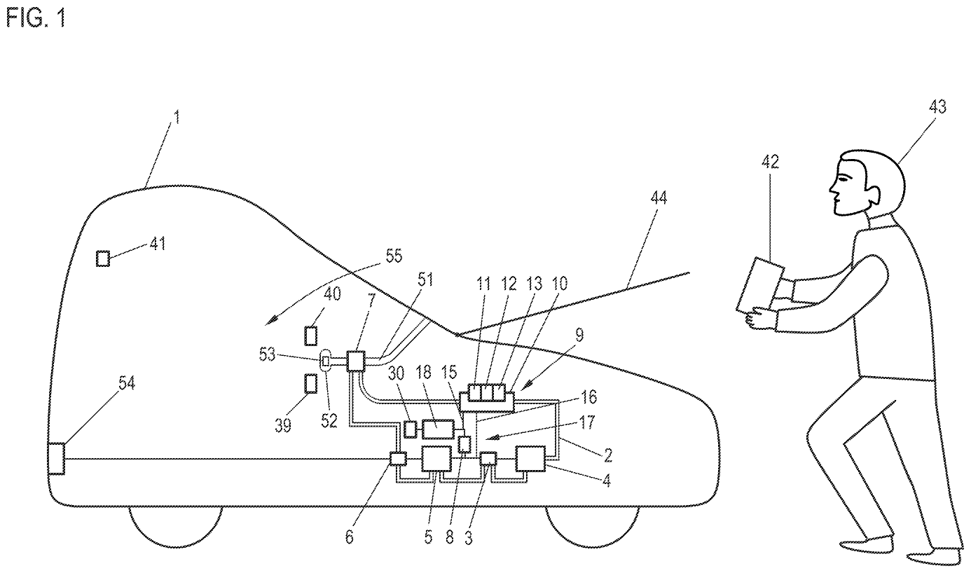

FIG. 1 shows a motor vehicle having multiple components 3 to 8 being heated, which can be heated by a heating fluid carried in a heating fluid circuit 2. A heating device 9 is used here to electrically heat the heating fluid.

For an adequate heating in different regions, different heating powers may be required on account of the different outdoor temperatures occurring there, in order to achieve an adequate comfort of use. At the same time, one should avoid carrying along a needlessly large dimensioned and thus needlessly heavy heating device. Therefore, a heating device 9 will be used which comprises a basic component 10 permanently installed in the motor vehicle 1 and carries, in the situation represented in FIG. 1, three separately configured removable heating modules 11, 12, 13, which together provide the heating power of the heating device 9. The heating device 9 here is situated in the front of the vehicle beneath the front hood 44, in order to be more easily accessible to the user 43, so that the user can remove, add, or replace the heating modules 11, 12, 13 as needed.

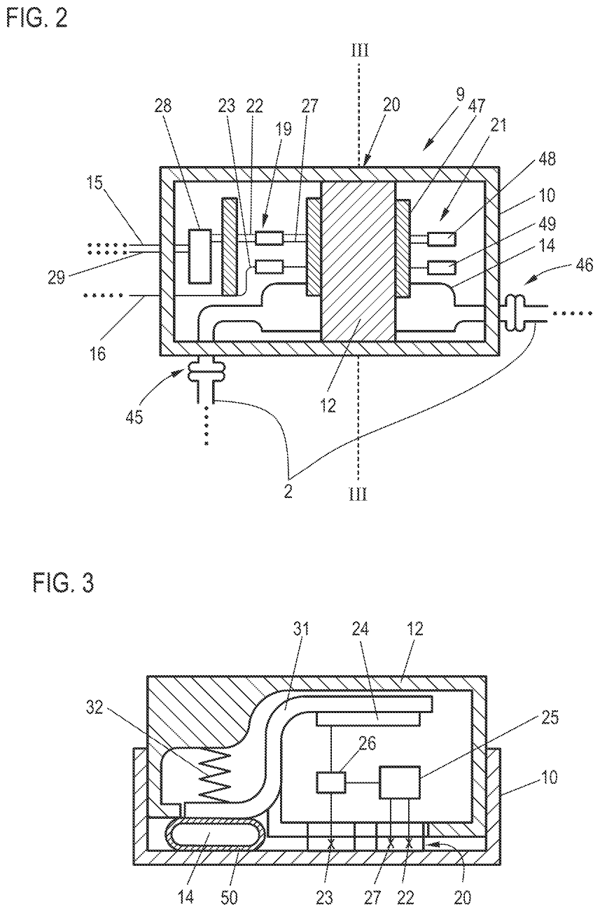

One possible configuration of the heating device 9 which makes this possible will be explained below with additional reference to FIGS. 2 and 3, where FIG. 2 is a top view of the heating device 9 in a condition in which it is occupied by only one heating module 12, and FIG. 3 is a cross sectional view along line III-III of FIG. 2.

The condition represented in FIG. 2 can be produced, for example, if the user 43 removes the heating modules 11 and 13 from the basic component 10. The heating device 9 is still operable here, but it has a lesser heating power, for example, only a third of the heating power when a heating occurs exclusively through the heating modules 11, 12, 13 and these have the same heating power.

The basic component 10 comprises a heating duct 14, which is connected by a fluid inflow 45 and a fluid outflow 46 to the heating fluid circuit 2 and is otherwise closed fluid-tight. Furthermore, the basic component 10 is connected by electrical leads 15, 16 to the onboard network 17 of the motor vehicle. The electrical lead 15 is connected to a low-voltage network, such as a 12 V network, which is powered by the battery 18. The low-voltage network also powers the central control device 30 of the motor vehicle, which communicates by the data connection 29 with the vehicle-installed control device 28 of the basic component 10 in order to control and monitor the operation of the overall heating device 9 as needed. For example, a control command of the control device 30 sent to the control device 28 can dictate the desired overall heating power.

The electrical lead 16 is connected to a high-voltage onboard network, which is powered by a high-voltage battery 5 and which is coupled across a component 8, especially a DC/DC converter, to the low-voltage network.

The basic component 10 in the example comprises three interfaces 19, 20, 21, each of which has current leads 22, 23, namely, a high-voltage and a low-voltage current connection, for the power supply of the heating modules 11, 12, 13 and being adapted to hold the respective heating module 11, 12, 13, as is shown schematically by the partition walls 47.

The electrical contacting of the respective heating module 11, 12, 13 occurs on the one hand by a plug connector 48, which on the one hand comprises the current connection 22 for the low-voltage power supply and on the other hand a data connection 27 for the communication between the local control device 25 of the respective heating module 11, 12, 13 shown in FIG. 3 and the control device 28 or 30. For example, by this data connection 27 the control device 28 can send instructions to the local control devices in order to set the heating powers of the heating modules 11, 12, 13 such that on the whole the overall heating power dictated by the central control device 30 is achieved.

The control device 28 may furthermore recognize, by means of the communication via the data connection 27, whether a particular interface 19, 20, 21 is occupied by a particular heating module 11, 12, 13 and also interrogate, for example, what maximum heating power can be provided by the particular heating module 11, 12, 13. In dependence on this, it can be determined in the control device 28 for example exactly how the existing heating modules 11, 12, 13 should work together in order to provide the heating power dictated by the control device 30, so that for example the most uniform possible workload of the heating modules 11, 12, 13 can be accomplished.

On the other hand, a high-voltage power supply of the respective heating module 11, 12, 13 occurs through the plug connector 49, comprising the current connection 23 to the high-voltage power supply.

The use of a local control device 25 has the benefit that a common high-voltage power supply can be used for all the heating modules 11, 12, 13. The actual heating power is dictated by the local control device 25 in dependence on the communication signals received by the data connection 27. In the example shown in FIG. 3, the local control device 25 for this purpose actuates a semiconductor switch 26, for example, in order to control a heating power supplied to the heating element 24 by pulse width modulation and optionally by a subsequent smoothing of the voltage, not shown.

In the most simple case, the heating element 24, being for example a PTC heating element, could make direct contact with an outer wall 50 of the heating duct 14. Depending on the specific configuration of the heating device 9 or the individual heating modules 11, 12, 13, however, a heat conduction means 31, such as a heat pipe, may be used to transmit heat from the heating element 24 to the heating duct 14. In order to achieve a good heat transfer, an elastic element 32 is used in the example shown in FIG. 3, being a spring in this case, in order to press the heat conduction means 31 against the outer wall 50 of the heating duct 14.

The heating fluid circuit 2 is shown schematically in FIG. 1 such that the components 3 to 7 which are being heated receive a flow in sequence. In actual motor vehicles, more complex heating fluid circuits are typically used, which also make it possible to heat only parts of the components 3 to 8 being heated and not flow through other of the components 3 to 8, or have a fluid flow through them which has been previously cooled by a device, not shown, so that the interior can continue to be heated, for example, while a battery can be cooled, or the like.

The components 3 and 6 in this case are each power electronics, component 3 being the pulse inverter for the propulsion motor, i.e., the likewise heated component 4, and component 6 being a charger electronics, which connects the high-voltage onboard network to the charging terminal 54 of the motor vehicle 1. In addition, the component 8, i.e., a DC/DC converter in particular, could be heated as power electronics. The component 5 is the high-voltage battery.

The heating device 9 may furthermore serve for heating the interior 55 of the motor vehicle 1. For this, a heat exchanger 7 may be connected to the heating fluid circuit 2, which heats the air supplied to the interior 55 of the motor vehicle 1. The air can be taken in, for example, through the air duct 51 from the outside and be delivered to the interior 55 through an outlet 52, wherein it flows through the heat exchanger 7 before being delivered to the interior 55 and thereby takes up heat from the heating fluid in the heating fluid circuit 2.

Since the heating fluid circuit 2 has a certain inertia, it may be advantageous to provide an additional heating element 53 in the flow path of the air, for example in the region of the outlet 52, which directly heats the air flowing past it. The heating element 53 may optionally be powered from the low-voltage or the high-voltage network of the motor vehicle 1.

A user 43 often cannot easily estimate the heating power which is presumably required for a future driving operation. It is therefore advantageous for the control device 30 or alternatively also the control device 28 to predict a presumably required heating power of the heating device 9 based on a current position and/or a planned travel destination and/or a planned travel route. The position, the destination, and the travel route may be provided, for example, by a navigation device 39 of the motor vehicle.

After this, for example with the aid of map data, received weather reports, etc., it is possible to determine outdoor temperatures presumably occurring in the region of the current position or the planned destination or along the travel route and, based on this, to predict the presumably required maximum heating power with the aid of a look-up table, a method trained by machine learning, or the like.

One can then determine how many or which heating modules 11, 12, 13 are presumably needed in order to provide an adequate heating power and occupancy information in this regard can be put out to the user 43. This may be done directly through an output device 40 of the motor vehicle 1, which may be for example a display or a loudspeaker. However, it may also be advantageous to relay this information via the output device 41, for example a transmitter for mobile communication, to an external device 42, such as a smartphone of the user 43, in order to be put out there.

In an alternative embodiment it would also be possible to perform the prediction of the presumably required heating power or the selection of a suitable occupancy outside of the motor vehicle, for example on a backend server of the vehicle manufacturer or by the external device 42 itself, for example, by an app which is executed on a smartphone.

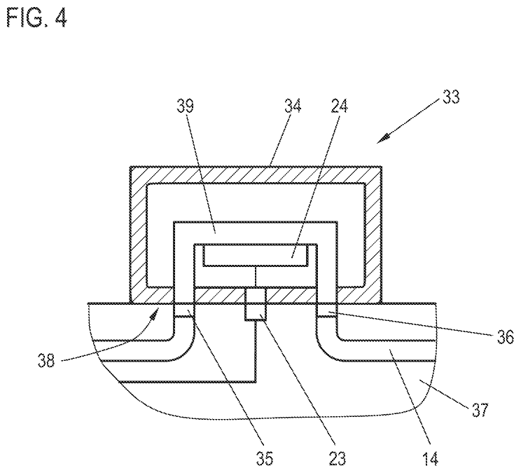

FIG. 4 shows a detail view of an alternative heating device 33, which can be used in the motor vehicle 1 in place of the heating device 9. There is shown here only a single interface 38 and a single heating module 34 arranged there. Further interfaces may be arranged outside the border of the figure, as explained for FIGS. 1 to 3, which can be occupied by further heating modules as needed.

The heating device 33 differs primarily from the above discussed heating device 9 in that the interface 38 used in FIG. 4 to receive the heating module 34 has fluid ports 35, 36, which connect a module duct 39 of the respective heating module 34 to the heating duct 14. Thus, the heating fluid is taken through the heating module 34 itself, which may make possible a better heat transfer and a quicker response time of the heating device 33. However, for this it is necessary to use relatively expensive interfaces 38 on account of the fluid ports 35, 36. The fluid ports 35, 36 may be self-sealing, for example, or valves may be arranged in the region of the fluid ports 35, 36, which are controlled for example by a control device of the basic component 37, not shown, in order to close the fluid ports 35, 36 when no heating module 34 occupies the respective interface 38.

A further difference between the heating device 33 and the heating device 9 is that the heating element 24 in the heating device 33 or in the heating module 34 is energized directly via the current connection 23. This makes possible a very simple design of the individual heating modules 34, but in order to control the heating power it is necessary to control the power supply via the current connection 23, for example via a control device of the basic component 37.

German patent application no. 10 2021 104371.9, filed Feb. 24, 2021, to which this application claims priority, is hereby incorporated herein by reference in its entirety.

Aspects of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A motor vehicle, comprising:
a heating fluid circuit by which a heating fluid can be taken to at least one component of the motor vehicle which is to be heated; and
a heating device to heat the heating fluid, wherein the heating device includes a basic component mounted in the motor vehicle, the basic component including a heating duct, which is part of the heating fluid circuit, and electrical connectors, which are connected to an onboard network of the motor vehicle;
wherein the basic component includes multiple interfaces for heating modules configured separately from the basic component, each of the interfaces including a current connection to a power supply of the respective heating module and adapted to hold the respective heating module, and wherein at least one of the interfaces is occupied by a heating module the operation of which provides heat for heating the heating fluid carried through the heating duct.

2. The motor vehicle according to claim 1, wherein the respective heating module encompasses at least one heating element and a local control device, wherein the local control device is adapted to receive communication signals via at least one data connection implemented by the interface and to control the energization of the heating element in dependence on these communication signals.

3. The motor vehicle according to claim 2, wherein the motor vehicle encompasses a vehicle-installed control device, which is adapted to control the heating power of the respective heating module by a communication with the local control device or one of those devices, which is part of the respective heating module, and/or by setting the power provided via the current connection to the respective heating module.

4. The motor vehicle according to claim 3, wherein the vehicle-installed control device is adapted to acquire on the one hand an occupancy information, which indicates whether a respective interface is occupied by a heating module and/or describes the at least one parameter of the heating module occupying the interface, and on the other hand to control the current heating power of the at least one heating module present in the heating device in dependence on the occupancy information.

5. The motor vehicle according to claim 1, wherein the heating duct is closed fluid-tight, except for a fluid inflow connected to the heating fluid circuit and a fluid outflow connected to the heating fluid circuit.

6. The motor vehicle according to claim 5, wherein a heating element of the respective heating module contacts the heating duct directly or across a heat pipe.

7. The motor vehicle according to claim 1, wherein the respective interface comprises fluid ports for the respective heating module, wherein the at least one heating module comprises a module duct, which is connected via the fluid ports of the respective interface occupied by the respective module to the heating duct.

8. The motor vehicle according to claim 3, wherein the vehicle-installed control device or a processing device of the motor vehicle is adapted to predict a presumably required heating power of the heating device based on the current position and/or a planned travel destination and/or a planned travel route of the motor vehicle, to select in dependence on this a suitable occupancy of the interfaces by heating modules and to actuate an output device of the motor vehicle to put out an occupancy information regarding the suitable occupancy to a user and/or to relay this to an external device.

9. The motor vehicle according to claim 1, wherein the respective interface and the respective heating module are adapted so that a connecting of the respective heating module to and/or a disconnecting of the respective heating module from the interface is possible without a tool.

10. The motor vehicle according to claim 1, wherein the heating fluid circuit is adapted so that the heating fluid can be carried to a heat exchanger for air being supplied to an interior of the motor vehicle and/or to a battery and/or to a power electronics and/or to an electric machine as the component being heated.

11. A method for adapting an available heating power in a motor vehicle, wherein the motor vehicle comprises a heating fluid circuit by which a heating fluid can be taken to at least one component of the motor vehicle which is to be heated, and a heating device to heat the heating fluid, wherein the heating device includes a basic component mounted in the motor vehicle, the basic component including a heating duct, which is part of the heating fluid circuit, and electrical connectors, which are connected to an onboard network of the motor vehicle, wherein the basic component includes multiple interfaces for heating modules configured separately from the basic component, each of the interfaces including a current connection to a power supply of the respective heating module and adapted to hold the respective heating module, and wherein at least one of the respective interfaces is occupied by a heating module the operation of which provides heat for heating the heating fluid carried through the heating duct, the method comprising:
adapting the available heating power by installing a heating module within at least one not yet occupied interface and/or removing at least one heating module occupying an interface.

12. The method according to claim 11, wherein a current position and/or a planned travel destination and/or a planned travel route of the motor vehicle is ascertained and a processing device predicts the presumably required heating power of the heating device based on the current position and/or the planned travel destination and/or the planned travel route of the motor vehicle and a suitable occupancy of the interfaces by heating modules is selected in dependence on this and an occupancy information regarding the suitable occupancy is put out to a user.

13. The method according to claim 11, wherein adapting the available hearing power includes replacing at least one heating module occupying an interface with another heating module.

14. The method according to claim 11, wherein the motor vehicle is an electrically-operator motor vehicle.

15. The method according to claim 11, wherein the heating fluid is water.
